(19) United States
(12) Patent Application Publication
(10) Pub. No.: US 2011/0290163 A1
(43) Pub. Date: Dec. 1, 2011

(54) HYBRID OXY-FUEL BOILER SYSTEM

(76) Inventor: Hisashi Kobayashi, Bedford, NY (US)

(21) Appl. No.: 12/787,425

(22) Filed: May 26, 2010

(51) Int. Cl. F23B 10/00; F23L 15/00; F02C 7/08; F23L 7/00; F23C 9/06

(52) U.S. Cl. 110/345; 110/214; 110/297; 110/234; 60/39.52; 110/302

(57) ABSTRACT

An air-fired combustion unit such as a utility boiler is converted to oxy-fired operation and a second oxy-fired combustion unit is operatively connected upstream so that its flue gas is fed into the combustion chamber of the first unit.

### FIELD OF THE INVENTION

The present invention relates to combustion systems such as boilers for generating steam and power, and relates especially to improvements in converting such systems to oxy-fuel operation to facilitate capture of carbon dioxide produced by the combustion.

### BACKGROUND OF THE INVENTION

One of the more economic ways to capture carbon dioxide that is produced by combustion of fuel and air in industrial furnaces such as coal fired boilers for electric power generation is to convert the furnace to oxy-fuel firing. Oxy-fuel combustion largely eliminates nitrogen contained in combustion air and the concentration of carbon dioxide in the flue gas can be increased above 90% after the water vapor in the flue gas has been condensed. However, the high adiabatic flame temperature of oxy-fuel combustion and the small flue gas volume cause heat transfer problems in boilers originally designed for fuel-air firing. Those skilled in the art have overcome the heat transfer problems by recycling an appropriate amount of flue gas and mixing it with oxygen prior to combustion with fuel. (References; R. Payne, S. L. Chen, A. M. Wolsky, W. F. Richter “CO2Recovery via Coal Combustion in Mixtures of Oxygen and Recycled Flue Gas” Combust. Sci. and Tech. 1989, Vol. 67, pp. 1-16; Dillon, D. J., White, V. and Allam, R. J., Wall, R. A. and Gibbins, J., “Oxy-Combustion Processes for CO₂ Capture From Power Plant”, IEA Greenhouse Gas R&D Programme, IEA Report Number 2005/9, July 2005.)

In general, the efficiency of capturing carbon dioxide that is produced by combustion is improved by carrying out the combustion with oxygen rather than air as the oxidant with which the fuel is combusted. However, converting an existing air-fired power plant to oxy-fuel combustion with flue gas recycle is expensive and also reduces the net power output by about 30%. The present invention enables the benefits of oxy-fuel combustion to be obtained in a new, efficient way.

### BRIEF SUMMARY OF THE INVENTION

One aspect of the present invention is a method of modifying a combustion system that comprises a first combustion chamber and that is capable of receiving fuel and air into said first combustion chamber and that is capable of combusting said fuel and said oxidant in said first combustion chamber, and a flue gas outlet from said first combustion chamber for gaseous products of combustion formed in said first combustion chamber, the method comprising
(A) providing a second combustion unit that includes a second combustion chamber and that is capable of receiving fuel and gaseous oxidant containing less than 10% nitrogen into said second combustion chamber and that is capable of combusting said fuel and said oxidant in said second combustion chamber, and that includes a flue gas outlet from said second combustion chamber for gaseous products of combustion formed in said second combustion chamber,
(B) coupling a source of gaseous oxidant having an oxygen content of at least 90 vol. % to said second combustion chamber for combustion thereof in said second combustion chamber,
(C) coupling a source of gaseous oxidant having an oxygen content of at least 90 vol. % to said first combustion chamber for combustion thereof in said first combustion chamber in place of air,
(D) coupling said flue gas outlet from said second combustion chamber to said first combustion chamber to feed gaseous combustion products formed in said second combustion chamber into said first combustion chamber, and
(E) coupling said flue gas outlet from said first combustion chamber to apparatus which is capable of concentrating and compressing carbon dioxide in said gaseous combustion products formed in said first combustion chamber.

Another aspect of the present invention is a combustion system that comprises
(A) a first combustion unit that includes a first combustion chamber and that is capable of receiving fuel and gaseous oxidant having an oxygen content of 19 to 35 vol. % into said first combustion chamber and that is capable of combusting said fuel and said oxidant in said first combustion chamber, and a flue gas outlet from said first combustion chamber for gaseous products of said combustion,
(B) a second combustion unit that includes a second combustion chamber and that is capable of receiving fuel and gaseous oxidant containing less than 10% nitrogen into said second combustion chamber and that is capable of combusting said fuel and said oxidant in said second combustion chamber, and a flue gas outlet from said second combustion chamber for gaseous products of said combustion,
(C) a conduit operatively connected to said flue gas outlet from said second combustion chamber and to said first combustion chamber to convey gaseous combustion products from said second combustion chamber into said first combustion chamber, and
(D) a conduit operatively connected from said flue gas outlet from said first combustion chamber to apparatus which is capable of concentrating and compressing carbon dioxide in said gaseous combustion products formed in said first combustion chamber.

Yet another aspect of the present invention is a method of combustion, comprising
(A) providing a combustion system that comprises
(i) a first combustion unit that includes a first combustion chamber and that is capable of receiving fuel and gaseous oxidant into said first combustion chamber and that is capable of combusting said fuel and said oxidant in said first combustion chamber, and a flue gas outlet from said first combustion chamber for gaseous products of said combustion,
(ii) a second combustion unit that includes a second combustion chamber and that is capable of receiving fuel and gaseous oxidant into said second combustion chamber and that is capable of combusting said fuel and said oxidant in said second combustion chamber, and a flue gas outlet from said second combustion chamber for gaseous products of said combustion,
(iii) a conduit operatively connected to said flue gas outlet from said second combustion chamber and to said first combustion chamber to convey gaseous combustion products from said second combustion chamber into said first combustion chamber, and
(iv) a conduit operatively connected from said flue gas outlet from said first combustion chamber to apparatus which is capable of concentrating and compressing carbon dioxide in said gaseous combustion products formed in said first combustion chamber; and
(B) feeding fuel and gaseous oxidant having an oxygen content of at least 90 vol. % to said first and second combustion chambers, and combusting fuel in both said combustion chambers, while feeding gaseous combustion products formed in said second combustion chamber from said second combustion chamber into said first combustion chamber, conveying gaseous combustion products from said first combustion chamber into said apparatus, and concentrating and compressing carbon dioxide in said apparatus.

Preferably in each of the above aspects of the invention the fuel comprises coal. However, the invention would work with other fuels, or combinations of fuels, such as coke, petroleum coke, biomass, natural gas, and fuel oil.

In each of these aspects of the invention, a preferred option is to provide for recycle of gaseous combustion products out of the first combustion chamber and then into the second combustion chamber, and more preferably removing sulfur oxide and nitrogen oxides from the gaseous combustion products after they pass out of the first combustion chamber before they are fed into the second combustion chamber.

### BRIEF DESCRIPTION OF THE DRAWINGS

FIG. 1 is a flowsheet of one conventional combustion system.

FIG. 1a is a flowsheet of a coal fired utility boiler system

FIG. 2 is a flowsheet of another conventional combustion system.

FIG. 3 is a flowsheet of one embodiment of the present invention.

FIG. 4 is a flowsheet of another embodiment of the present invention.

FIG. 5 is a flowsheet representing an example of conventional conversion of an existing air fired furnace to oxy-fuel firing

FIG. 6 is a flowsheet representing another example of a prior art conversion of an existing air fired furnace to oxy-fuel firing by replacing the entire existing boiler and steam turbine with a new high efficiency boiler and steam cycle.

FIG. 7 is a flowsheet representing an example of a preferred arrangement of the present invention with a new oxy-coal fired boiler.

FIG. 8 is a flowsheet representing another preferred arrangement according to the present invention with a new oxy-coal fired boiler with cooled flue gas feeding into the existing boiler to eliminate flue gas recycle for the existing boiler.

FIG. 9 is a flowsheet representing an alternative embodiment wherein a gas turbine topping cycle is employed with flue gas recirculation from the first boiler.

### DETAILED DESCRIPTION OF THE INVENTION

Referring first to FIG. 1, boiler 1 is of any known design to which fuel 2 and air 3 are fed and combusted within boiler 1 to produce heat and gaseous combustion products 4. The heat is typically recovered by indirect convective and radiative heat transfer to water, which is converted to steam, and heat transfer to the steam. The steam can then be used to operate turbines to produce electric power.

The gaseous combustion products 4 are preferably fed to unit 5 which may consist of more than one modules and pollutants such as ash particulates, sulfur oxides and nitrogen oxides are removed from the gas 4. The resulting cleaned flue gas 6 exits unit 5 and can be vented to the atmosphere through a stack or fed to other processes.

FIG. 1a shows a more detailed flow sheet of a coal fired utility boiler, which represents a preferred combustion system in which the present invention is useful. Boiler 1 is of any known design to which fuel 2 and air 3 are fed and combusted to produce heat and gaseous combustion products 4. The gaseous combustion products 4 pass through heat recovery area 112, often know as convective banks, which may include superheaters, reheaters, and economizers to transfer heat to feed water 113 to produce steam and/or hotter water which are represented by 114. The gaseous combustion products 42 are optionally fed to unit 51 such as a selective catalytic converter to reduce the amount of NOx species in the gaseous stream. The resulting stream 43 of gaseous combustion products is then fed to an air heater 61 to preheat combustion air stream 3 to a temperature typically in a range of 500 to 800 F. The resulting gaseous combustion products 44 then pass through an ash removal unit 52, typically an electrostatic precipitator, to remove solid particulates such as ash particles which are usually present in flue gas from coal combustion. The resulting gaseous combustion products 45 are optionally treated in a desulfurization unit 53 to reduce the concentration of SOx species. The resulting cleaned flue gas 6 is vented to the atmosphere through a stack, not shown.

The air pollution control unit disclosed here, such as unit 5 in FIG. 1, can comprise any one, or any combination, of units such as units 51, 52 and/or 53.

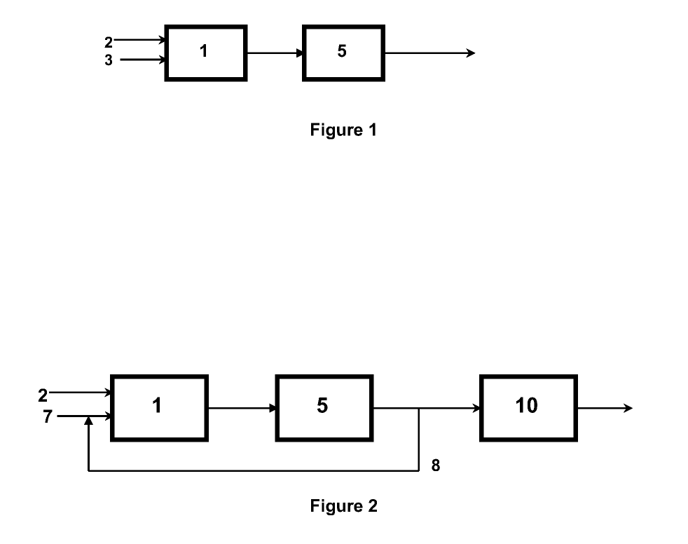

FIG. 2 shows another conventional embodiment of a combustion system enabling the use of oxygen in place of air as the oxidant for combustion for a boiler designed to use for combustion. Fuel 2 and oxygen 7 typically comprising at least 80 vol. % oxygen are fed to boiler 1 and are combusted. Preferably the oxidant comprises at least 90 vol. % oxygen, and more preferably it contains at least 95 vol. % oxygen. The gaseous products of this combustion leave boiler 1 as stream 4 which is preferably treated in unit 5 to remove pollutants such as particulates, sulfur oxides and nitrogen oxides. A portion 8 of the cleaned flue gas 6 which leaves unit 5 is recycled to boiler 1. Optionally a portion of water vapor contained in gaseous combustion products 4 is condensed and removed prior to recycle to boiler 1. Optionally a portion of gaseous combustion products 4 are recycled to boiler 1 prior to the treatment in unit 5, which is not shown in FIG. 2. Another portion 9 of stream 6 is further cooled to condense and remove water vapor and recovered for storage or sequestration, optionally preceded by treatment to raise (enrich) the carbon dioxide content of the stream. Such treatment can be implemented by any of several known processes such as cryogenic carbon dioxide separation processes and preferential absorption or adsorption of carbon dioxide followed by desorbtion or desorption. Examples include preferential absorption of carbon dioxide into an aqueous solution of organic amines, followed by stripping the carbon dioxide from the aqueous solution. Preferably carbon dioxide is separated from other gases by a cryogenic process. The steps of water vapor condensation, recovery, storage and sequestration, and optional enrichment are represented by stage 10 in FIG. 2. Oxygen 7 is preferably premixed with recycled flue gas stream 8 prior to being fed to boiler 1. Optionally a portion of oxygen 7 can be directly injected into boiler 1. The amount of flue gas stream 8 recycled to boiler 1 is controlled so as to be able to operate boiler 1 with no or minimum modifications. The average oxygen concentration of the mixture of oxygen and the recycled flue gas that enables the proper operation of boiler 1 is typically in a range of 23 and 30 vol. %.

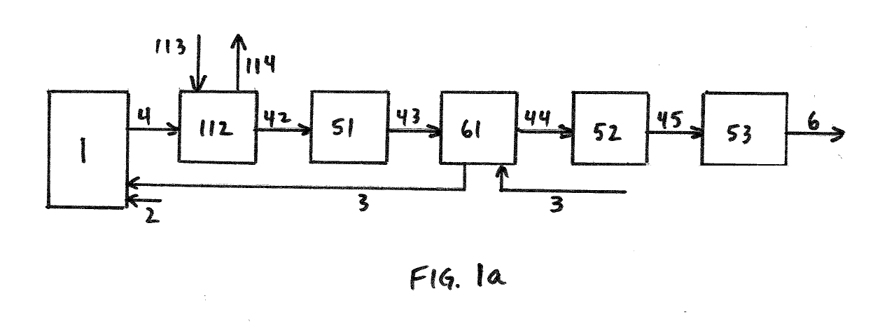

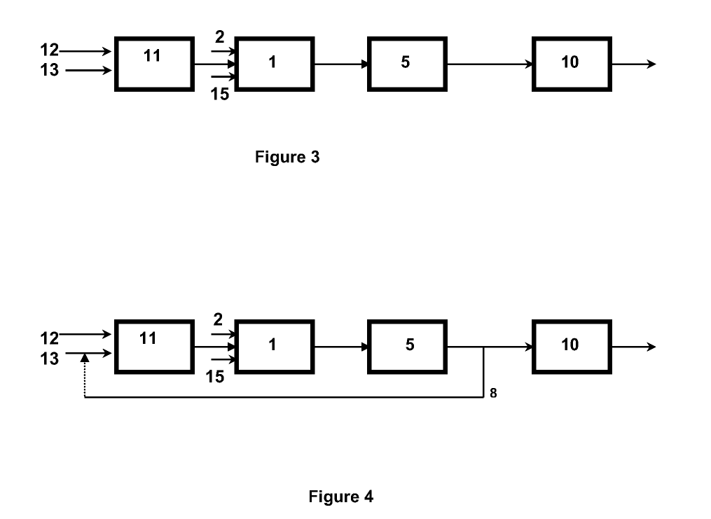

FIG. 3 shows an embodiment of the present invention. A second boiler 11 is provided, into which are fed fuel 12 and oxygen (preferably comprising at least 80 vol. % oxygen). Combustion of the fuel and oxygen in boiler 11 produces gaseous combustion products which exit boiler 11 as stream 14. Optionally boiler 11 has a flue gas recycle loop 30 of its own, in which case oxygen and recycled flue gas are fed to the combustion chamber. In all cases described herein wherein oxidant and recycled flue gas are fed to a combustion chamber, they can be fed separately or as a premixed stream.

In all cases described herein wherein flue gas is recycled and fed to a combustion chamber, the combined content of oxygen, carbon dioxide and water vapor fed to the combustion chamber should be at least 80 vol. %.

In all cases in which fuel and oxidant (being air or oxygen, with or without recycled flue gas) are fed to a combustion chamber, the fuel and oxidant can be fed into the combustion chamber as separate streams or can be premixed outside the combustion chamber to form a combined stream which is then fed into the combustion chamber.

Oxidant can all be fed to the combustion chamber in one location, but typically a portion of the oxidant is fed in a primary stream with the fuel, and another portion is fed as a secondary stream near the point of entry of the primary stream.

The major composition of stream14 exiting boiler 11 when a bituminous coal is used as the fuel is typically: CO₂, 59 to 66 vol. %; H₂O, 26 to 31 vol. %; O₂, 2 to 4 vol. %; N₂, 1 to 10 vol. %; Ar, 0 to 4 vol. %; depending on the purity of oxygen used. For coal fired boilers stream 14 also contains minor concentrations of sulfur oxides, nitrogen oxides, various ash particulates.

Stream 14 is fed into the combustion chamber of boiler 1, preferably without passing through the air heater of boiler 1. Often, 100% of stream 14 from boiler 11 is fed into boiler 1, but in other embodiments less than 100% may be fed, such as at least 50 vol. %, and more preferably at least 75 vol. %.

The temperature of stream 14 exiting from boiler 11 is typically 350 to 800 F. Preferably the temperature of stream 14 is below the maximum allowable temperature of preheated combustion air for boiler 1 in order to avoid upgrading of the existing preheated air duct and the wind box. Optionally stream 14 is cooled by additional feed water heaters to 300 to 400 F. and fed to the air heater of boiler 1 for preheating Referring still to FIG. 3, oxygen stream 15 containing at least 80 vol. % oxygen is fed to boiler 1 instead of air as was shown in FIGS. 1, 1a and 2. Oxygen stream 15 can be premixed with flue gas stream 14 from boiler 11 prior to being fed to boiler 1 which may allow the use of the existing burners designed for air without modifications. Converting an existing air-fired system to the system of the present invention may require providing a burner that can be used for combusting fuel, flue gas from boiler 11 and oxygen, and providing a connection of the burner to a source of oxygen having the desired high oxygen content. Such sources are well known and include on-site plants such as cryogenic air separation plants, pressure swing adsorption and vacuum pressure swing adsorption units; alternatively, the connection is to an oxygen pipeline connected to a source of oxygen.

Boiler 11 is sized to produce a sufficient volume of flue gas to be fed to boiler 1 so as to eliminate the need for recycle of flue gas to boiler 1 as shown in FIG. 2.

Combustion in boiler 1 according to the embodiment of FIG. 3 produces the aforementioned stream 4 of gaseous combustion products, but in this embodiment the composition of stream 14, assuming boiler 1 is fired with a bituminous coal is typically: CO₂, 59 to 66 vol. %; H₂O, 26 to 31 vol. %; O₂, 2 to 4 vol. %; N₂, 1 to 10 vol. %; Ar, 0 to 4 vol. %; depending on the purity of oxygen used. For coal fired boilers stream 14 also contains minor concentrations of sulfur oxides, nitrogen oxides, various ash particulates.

In the present invention, the air heater shown in FIG. 1a is no longer needed and is bypassed by gaseous combustion products 4. In place of the air heater, an auxiliary feed water heater 31 is preferably installed to cool stream 4 to an appropriate temperature prior to being treated in unit 5. The addition of an auxiliary feed water heater has a beneficial effect of increasing the amount of steam produced and hence can potentially increase the power output of steam turbines fed by steam produced by the boilers. Stream 4 is treated in unit 5 to remove pollutants, such as sulfur oxides and nitrogen oxides, producing cleaned flue gas stream 6 which can be treated in unit 10 as described above for enrichment, storage and/or sequestration of the carbon dioxide.

FIG. 4 shows another embodiment of the invention, identical to the embodiment as described above with reference to FIG. 3, except that a portion 8 of stream 6 of gaseous combustion products is recycled and fed to boiler 11. As disclosed above, the recycled stream and the oxidant are fed to the combustion chamber separately or in a premixed stream. The amount of recycled flue gas stream portion 8 recycled to boiler 1 is controlled so as to be able to operate boiler 1 properly with no or minimum modifications. The average oxygen concentration of the mixture of oxygen, flue gas stream 14 from boiler 11 and recycled flue gas stream portion 8 that enables the proper operation of boiler 1 is typically in a range of 23 and 30 vol. %.

Portion 9 of stream 6 is fed to stage 10 for enrichment, storage and/or sequestration as described above. This embodiment reduces the volume of the flue gas being recycled compared to the recycled flue gas in FIG. 2.

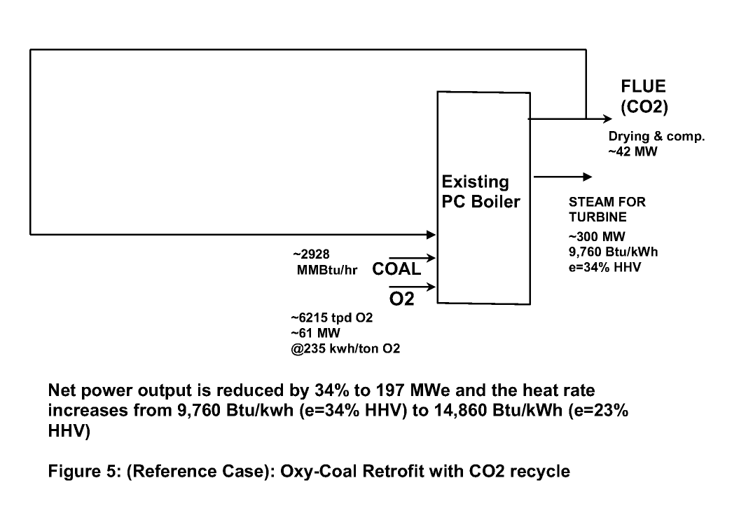

FIGS. 5-9 represent graphically baseline combustion systems and combustion systems according to the present invention, together with representative input and output data.

FIG. 5 shows an example representing a conventional conversion of an existing air fired furnace to oxy-fuel firing as described in FIG. 2. Due to a large parasitic power requirement the fuel to power conversion efficiency of the plant is reduced from 34% for a sub-critical boiler with air-coal firing to 23% for oxy-coal firing with flue gas recirculation. The net power output is reduced from 300 MW to 197 MW, i.e. 34% reduction. The reduced power output has to be made up by building a new power plant capacity with carbon capture and storage capability which require a significant additional capital investment.

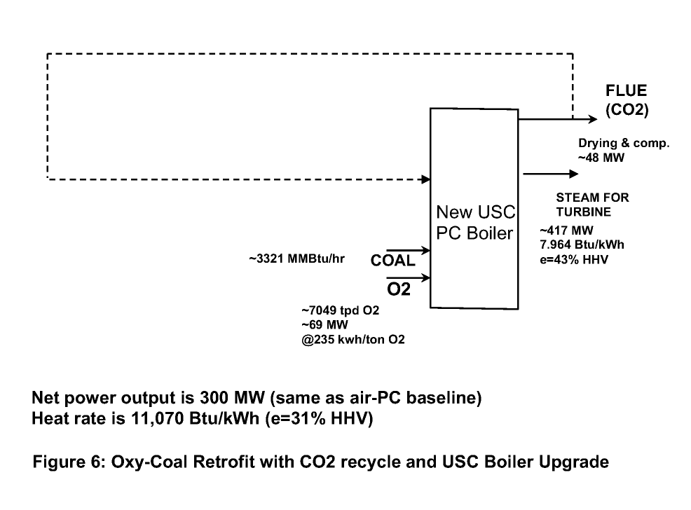

FIG. 6 shows another example representing a prior art conversion of an existing air fired furnace to oxy-fuel firing by replacing the entire existing boiler and steam turbine with a new high efficiency boiler and steam cycle called ultra-super critical boiler with a conversion efficiency of 43%. Although much higher power efficiency of 31% is realized, the new boiler has to be sized to generate 417 MW to offset the parasitic power of 117 MMW. The capital investment becomes very large just to maintain the same power output as the existing plant.

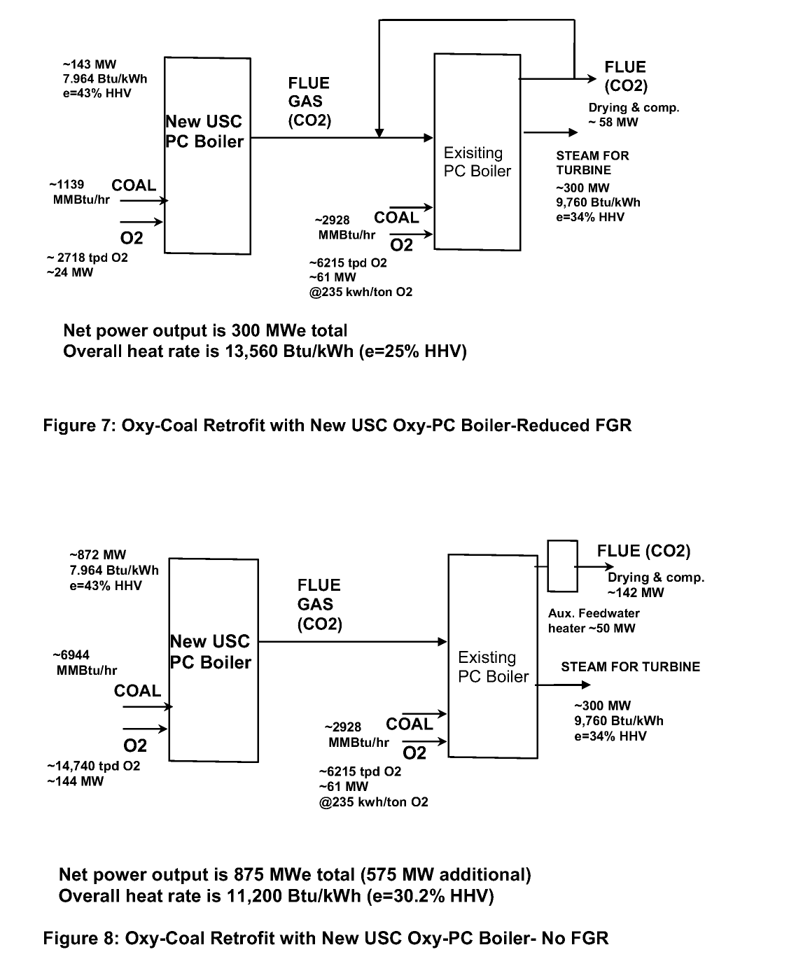

FIG. 7 shows an example of a preferred arrangement of the present invention with a new oxy-coal fired boiler with its flue gas feeding into the existing boiler to reduce the amount of the flue gas recycle for the existing boiler. This process integration scheme produces additional power from the new boiler—steam turbine cycle (not shown), which is sized to compensate for the parasitic power required for the production of oxygen in the air separation unit or for the compression and separation of CO₂ from flue gas. Since the size of the new boiler is 143 MW (vs, 417 MW for the embodiment of FIG. 6), the capital cost of the new boiler is reduced substantially and still produces the same net power output of 300 MW. The overall efficiency of this hybrid configuration is 25% and better than the embodiment of FIG. 5.

FIG. 8 shows another preferred arrangement according to the present invention with a new oxy-coal fired boiler with its cooled flue gas feeding into the existing boiler to eliminate the flue gas recycle for the existing boiler. An auxiliary feed water heater is installed to recover heat from flue gas, bypassing the original air heater. This process integration scheme produces a substantial additional power from the new boiler—steam turbine cycle (not shown), as it is sized to fully utilize the capacity of the existing boiler and flue gas pollution control units. The size of the new boiler is 872 MW and the net power output of the plant, after subtracting the parasitic power required for the production of oxygen in the air separation unit and for the compression and separation of CO₂ from flue gas, is 875 MW, an increase of 575 MW. The overall efficiency of this hybrid configuration is 30.3% and this configuration may be a viable repowering option for the existing plant to meet the growing future demand for power while reducing emissions of CO₂ from the current source.

In the above examples, the second combustion boiler 11 was assumed to be an “ultra supercritical” (USC) PC boilers. The second boiler can be of any type, including CFB boilers, cyclone boilers or tangentially fired boilers and the steam cycle pressure can be ultra super critical, or super critical or sub-critical. Any fuel can be used as long as the oxidant has a high concentration of oxygen, preferably more than 90% O₂, more preferably more than 95% O₂ concentration. The combustion chambers should produce combustion flue gas containing more than 70 vol. % of (CO₂ plus H₂O), preferably more than 90% (CO₂ plus H₂O), and most preferably, more than 95% (CO₂ plus H₂O). This means that components such as N₂, excess O₂, and argon should be minimized by using fuels containing low concentrations of “inert” and minimizing air infiltration into the combustion process. In fact the second combustion unit 11 can be any combustion unit that produces cooled flue gas containing 70% (CO₂+H₂O), preferably more than 90% (CO₂+H₂O), most preferably, more than 95% (CO₂+H₂O). For example, oxygen fired industrial furnaces such as cement kilns, petroleum heaters and steel heating furnaces can be utilized as the second combustion unit 11. More than one combustion unit can be used as well, for example, three parallel upstream boilers feeding into an existing boiler.

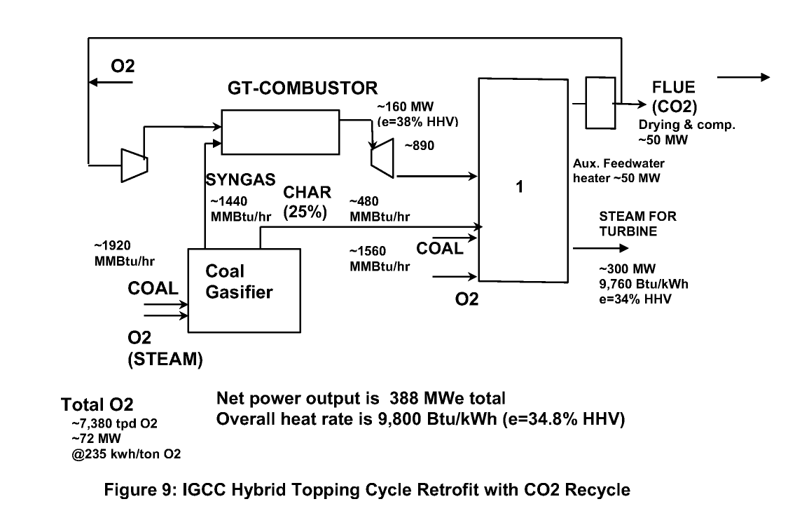

FIG. 9 shows an alternative embodiment wherein a gas turbine topping cycle is employed with flue gas recirculation from the first boiler 1. In this embodiment, the second combustion unit is gas turbine combustor 91 which is fired with gaseous fuel such as natural gas, and with oxidant which is a mixture of recycled flue gas and high-purity (≧90 vol. %) oxygen. This process can optionally be employed in conjunction with a coal gasification unit 92 which produces gaseous fuel 93 for the combustor/gas turbine 91 and char 94 for the existing boiler 1.

### Advantages

The methods and apparatus of the present invention can provide additional power from the second boiler, a portion or all of which can be used to for the production of oxygen in an air separation unit and/or for the compression and separation of CO₂ from flue gas.

The present invention enables a cost effective conversion of existing combustion units, such as utility boilers, to oxy-fuel (oxy-coal) firing with a reduced requirement for flue gas recirculation, while at the same time maintaining or increasing the power output from the plant. Since the existing pollutant control unit 5 already in place to treat the flue gas from the first combustion unit is utilized to control the emissions from the second combustion unit as well, a significant reduction in the capital cost of the new boiler system is realized compared to having to provide two separate pollutant control units.

The present invention also enables combustion, and power generation, to be carried out at a considerable gain in efficiency compared to other approaches to converting existing air-fired combustion units to oxy-fired, even taking into account the power requirements for providing the high-oxygen-content oxidant which replaces air in the existing combustion unit, and taking into account the power requirements for the carbon dioxide recovery unit 10 which often requires compression of the carbon dioxide to elevated pressure. This gain in efficiency (i.e. as overall energy input required for a given power output) and in cost effectiveness (i.e. as incremental additional cost) is considerable compared for instance to replacing the existing boiler and steam turbine with a larger and more efficient boiler-steam turbine system to provide the additional power needed for oxygen generation and carbon dioxide capture (which besides the additional cost would eliminate the remaining life of the existing unit).

Another advantage of the present invention is that not so large a duct and control system is needed to provide flue gas recirculation (i.e. comparing the system of FIG. 4 with the system of FIG. 2), and the problem of susceptibility to air leakage into the flue gas recirculation loop is diminished (the power requirement for the separation and recovery of CO₂ in unit 10 is very sensitive to the concentration of CO₂ in the flue gas stream and increases dramatically with the amount of air leakage into the system).

Thus it is a highly desirable advantage of the present invention that the benefits available up to now only with retrofitting an air-fired boiler with flue gas recirculation can be attained in the present invention without requiring flue gas recirculation (or with only a relatively reduced amount of flue gas recirculation).

What is claimed is:

1. A combustion system that comprises
(A) a first combustion unit that includes a first combustion chamber and that is capable of receiving fuel and gaseous oxidant having an oxygen content of 19 to 35 vol. % into said first combustion chamber and that is capable of combusting said fuel and said oxidant in said first combustion chamber, and a flue gas outlet from said first combustion chamber for gaseous products of said combustion,
(B) a second combustion unit that includes a second combustion chamber and that is capable of receiving fuel and gaseous oxidant containing less than 10% nitrogen into said second combustion chamber and that is capable of combusting said fuel and said oxidant in said second combustion chamber, and a flue gas outlet from said second combustion chamber for gaseous products of said combustion,
(C) a conduit operatively connected to said flue gas outlet from said second combustion chamber and to said first combustion chamber to convey gaseous combustion products from said second combustion chamber into said first combustion chamber, and
(D) a conduit operatively connected from said flue gas outlet from said first combustion chamber to apparatus which is capable of concentrating and compressing carbon dioxide in said gaseous combustion products formed in said first combustion chamber.

2. The apparatus of claim 1 wherein said fuel which said first combustion unit is capable of receiving and combusting is coal.

3. The apparatus of claim 1 wherein said first combustion unit is a boiler.

4. The apparatus of claim 1 wherein said second combustion unit is a gas turbine.

5. The apparatus of claim 1 further comprising a conduit operatively connected to said flue gas outlet from said first combustion chamber to recycle gaseous combustion products formed in said first combustion chamber into first combustion chamber.

6. A method of modifying a combustion system that comprises a first combustion chamber and that is capable of receiving fuel and air into said first combustion chamber and that is capable of combusting said fuel and said oxidant in said first combustion chamber, and a flue gas outlet from said first combustion chamber for gaseous products of combustion formed in said first combustion chamber, the method comprising
(A) providing a second combustion unit that includes a second combustion chamber and that is capable of receiving fuel and gaseous oxidant containing less than 10% nitrogen into said second combustion chamber and that is capable of combusting said fuel and said oxidant in said second combustion chamber, and that includes a flue gas outlet from said second combustion chamber for gaseous products of combustion formed in said second combustion chamber,
(B) coupling a source of gaseous oxidant having an oxygen content of at least 90 vol. % to said second combustion chamber for combustion thereof in said second combustion chamber,
(C) coupling a source of gaseous oxidant having an oxygen content of at least 90 vol. % to said first combustion chamber for combustion thereof in said first combustion chamber in place of air,
(D) coupling said flue gas outlet from said second combustion chamber to said first combustion chamber to feed gaseous combustion products formed in said second combustion chamber into said first combustion chamber, and
(E) coupling said flue gas outlet from said first combustion chamber to apparatus which is capable of concentrating and compressing carbon dioxide in said gaseous combustion products formed in said first combustion chamber.

7. The method of claim 6 wherein said fuel which said first combustion unit is capable of receiving and combusting is coal.

8. The method of claim 6 wherein said first combustion unit is a boiler.

9. The method of claim 6 wherein said second combustion unit is a gas turbine.

10. The method of claim 6 wherein said flue gas outlet from said first combustion chamber is coupled to an inlet in said second combustion chamber so that a portion of gaseous combustion products formed in said first combustion chamber can be recycled out of said first combustion chamber and into said second combustion chamber.

11. The method of claim 6 wherein said combustion system that is modified comprises an air heater that is coupled to said first combustion chamber so that gaseous products of combustion formed in said first combustion chamber, and air to be combusted in said first combustion chamber, can pass through said air heater so that said gaseous products of combustion can preheat said air in said air heater, and said method of modifying further comprises uncoupling said air heater so that said gaseous products of combustion in said first combustion chamber cannot preheat air.

12. The method of claim 11 further comprising providing a feed water heater and coupling said feed water heater to said first combustion unit so that gaseous products of combustion formed in said first combustion chamber can heat water which is then fed to said first combustion unit to be heated.

13. A method of combustion, comprising
(A) providing a combustion system that comprises
(i) a first combustion unit that includes a first combustion chamber and that is capable of receiving fuel and gaseous oxidant into said first combustion chamber and that is capable of combusting said fuel and said oxidant in said first combustion chamber, and a flue gas outlet from said first combustion chamber for gaseous products of said combustion,
(ii) a second combustion unit that includes a second combustion chamber and that is capable of receiving fuel and gaseous oxidant into said second combustion chamber and that is capable of combusting said fuel and said oxidant in said second combustion chamber, and a flue gas outlet from said second combustion chamber for gaseous products of said combustion,
(iii) a conduit operatively connected to said flue gas outlet from said second combustion chamber and to said first combustion chamber to convey gaseous combustion products from said second combustion chamber into said first combustion chamber, and
(iv) a conduit operatively connected from said flue gas outlet from said first combustion chamber to apparatus which is capable of concentrating and compressing carbon dioxide in said gaseous combustion products formed in said first combustion chamber; and
(B) feeding fuel and gaseous oxidant having an oxygen content of at least 90 vol. % to said first and second combustion chambers, and combusting fuel in both said combustion chambers, while feeding gaseous combustion products formed in said second combustion chamber from said second combustion chamber into said first combustion chamber, conveying gaseous combustion products from said first combustion chamber into said apparatus, and concentrating and compressing carbon dioxide in said apparatus.

14. The method of claim 13 wherein said fuel which said first combustion unit is capable of receiving and combusting is coal.

15. The method of claim 13 wherein said first combustion unit is a boiler.

16. The method of claim 13 wherein gaseous combustion products formed in said first combustion chamber are recycled out of said first combustion chamber and into said second combustion chamber.
